(19) United States
(12) Patent Application Publication
(10) Pub. No.: US 2014/0026528 A1
(43) Pub. Date: Jan. 30, 2014

(54) Resilient mounting joint for a sickle bar

(71) Applicant: Bruno Thiboutot, Saint-Andre de Kamouraska (CA)

(72) Inventor: Bruno Thiboutot, Saint-Andre de Kamouraska (CA)

(21) Appl. No.: 13/507,757

(22) Filed: Jul. 26, 2012

(51) Int. Cl. A01D 34/06; F16C 11/04; A01D 34/03

(52) U.S. Cl. 56/10.7; 56/264; 403/53

(57) ABSTRACT

The mounting joint has a first and second axes extending at right angle from each other. A shaft and bearing assembly extends along the first axis. The shaft has a crank arm on its end for controllably rotating the shaft axially about the first axis. The mounting joint also has a resilient wrist pin assembly mounted along the second axis. The resilient wrist pin assembly has axial resilience about the second axis. The first axis extends horizontally. The second axis always lies in a vertical plane. The shaft and bearing assembly has a first connection for connection to a supporting beam and a second connection connected to the resilient wrist pin assembly. The resilient wrist pin assembly has a third connection connected to the sickle bar, such that the sickle bar is controllably rotatable about the first axis and resiliently rotatable about the second axis.

### FIELD OF THE INVENTION

This invention pertains to tractor-mounted brush-cutting sickle bars, and more particularly, it pertains to resilient mounting joints for sickle bars that are operable in horizontal and vertical positions for cutting vegetation along forest roads.

### BACKGROUND OF THE INVENTION

Conventional sickle bars remain the implements of choice for cutting grass, hay, weeds, bushes and for trimming small branches along forest roads. Although conventional sickle bars are sturdy and efficient, their mounting joints are sometimes mechanically complex. These joints include power transmission linkages for operating the cutting bar. These complicated moving parts are easily damaged by the shocks and wear associated with the nature of this work.

Only one example of a sickle bar for cutting vegetation along forest roads has been found in the prior art.

Canadian Patent 510,271 issued to Earl W. Holmes on Feb. 22, 1955. This document describes a truck-mounted turret and telescoping boom. A sickle bar is mounted to the end of the telescoping boom. The sickle bar is operable at all angles starting below a horizontal position to a vertical position. Abnormal shocks on the sickle bar when the sickle bar is in a horizontal position are absorbed by an hydraulic cylinder and a pressure relief valve on the rotating base of the turret. The same mechanism is used to indirectly absorb stresses when the sickle bar is operated in the vertical position.

Although the machine of the prior art deserves undeniable merits, it is believed that there is a market need for a better mounting joint for a brush-cutting sickle bar. There is a market need for a mounting joint that can effectively absorb shocks whether the sickle bar is in a horizontal alignment or in a vertical orientation. It is believe that there is a need in this field for a mounting joint that is simple to build; that is sturdy and which can improve the cutting efficiency of the sickle bar.

### SUMMARY OF THE INVENTION

In the present invention, there is provided a new and improved mounting joint for a brush-cutting sickle bar. The mounting joint is relatively inexpensive to build. It is compact in size and easy to install. Its operation is advantageous for absorbing shocks on the sickle bar and for converting these shocks into torsion stresses on the branches being cut to facilitate the cutting of branches.

In one aspect of the present invention, there is provided a joint for installation between a tractor-mounted frame and a sickle bar. This mounting joint has a first and second axes extending at right angle from each other. A shaft and bearing assembly extends along the first axis. The shaft has mobility relative to the bearing housing and comprises a crank arm mounted on the end thereof for controllably turning the shaft about the first axis.

The mounting joint also has a resilient wrist pin assembly mounted along the second axis. The resilient wrist pin assembly has torsional resilience about the second axis. The shaft and bearing assembly has a first connection for connecting to the tractor-mounted frame and a second connection for connecting to the resilient wrist pin assembly. The resilient wrist pin assembly has a third connection for connecting to the sickle bar such that the sickle bar is controllably rotatable about the first axis and resiliently rotatable about the second axis.

The first axis always extends horizontally and the second axis always lies in a vertical plane, such that the sickle bar is selectively movable for operation in a horizontal position or in a vertical position. Shocks on the sickle bar from cutting branches cause the sickle bar to resiliently tilt about the second axis thereby applying torsion stresses on the branches being cut to facilitate the cutting of these branches. This phenomenon occurs whether the sickle bar is operated horizontally or vertically.

The mounting joint according to the present invention is susceptible of a low cost of manufacture with regard to both materials and labour and which accordingly is then susceptible of low prices of sale to the consumer, thereby making such mounting joint economically available to the public.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 is a front view of a tractor-mounted sickle bar and the mounting joint therefor supporting the sickle bar to a telescoping boom, in a horizontal orientation;

FIG. 2 shows the sickle bar in a vertical orientation;

FIG. 3 shows a perspective view of the preferred mounting joint;

FIG. 4 is a top view of the preferred mounting joint in use;

FIG. 5 is an enlarged plan view of a portion of the sickle bar shown in detail circle 5 in FIG. 4.

### DESCRIPTION OF THE PREFERRED EMBODIMENT

Referring firstly to FIGS. 1 to 3, the preferred mounting joint 20 for a sickle bar 22 is illustrated therein and will be described.

The sickle bar 22 is preferably mounted to the quick attachment frame, or quick coupler 24 on the front-loader arms of a farm tractor 26. A hollow beam 28 is attached to the quick coupler 24. An extension beam 30 is telescopically mounted in the hollow beam 28. The extension beam 30 is adjustable inside the hollow beam 28 and it is locked in position inside the hollow beam 28 by means of a pin 32 for example. The preferred mounting joint 20 is affixed to the end on the extension beam 30.

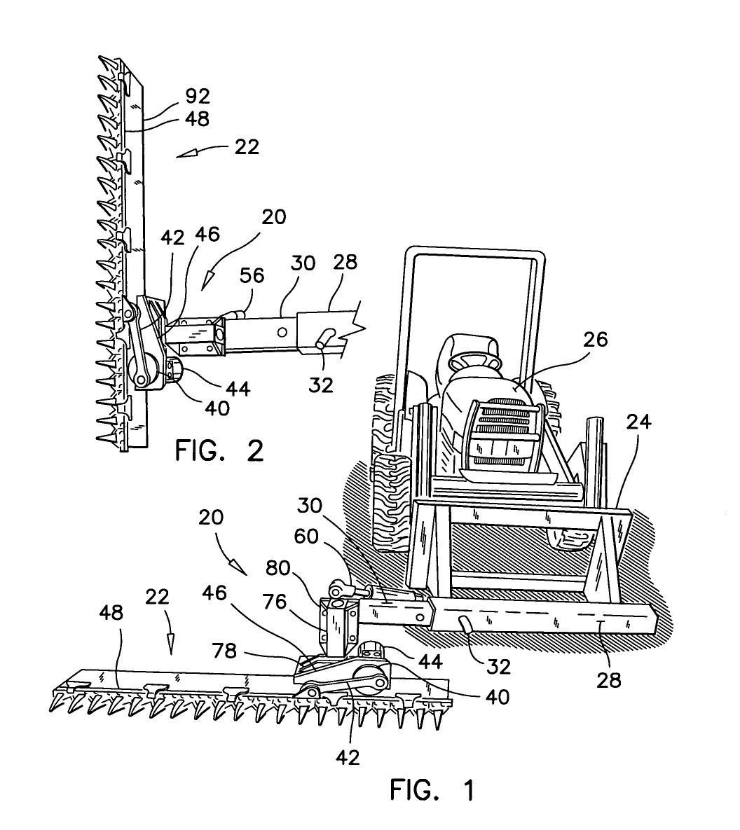

As can be seen on FIGS. 1 and 2, the sickle bar 22 is driven by a crank disc 40 and a pitman-type connecting rod 42. The crank disc 40 is driven by an hydraulic motor 44 that is retained to support bracket 46. The driven end of the connecting rod 42 is connected to the movable blade portion 48 of the sickle bar 22, for moving the blade portion 48 back and forth.

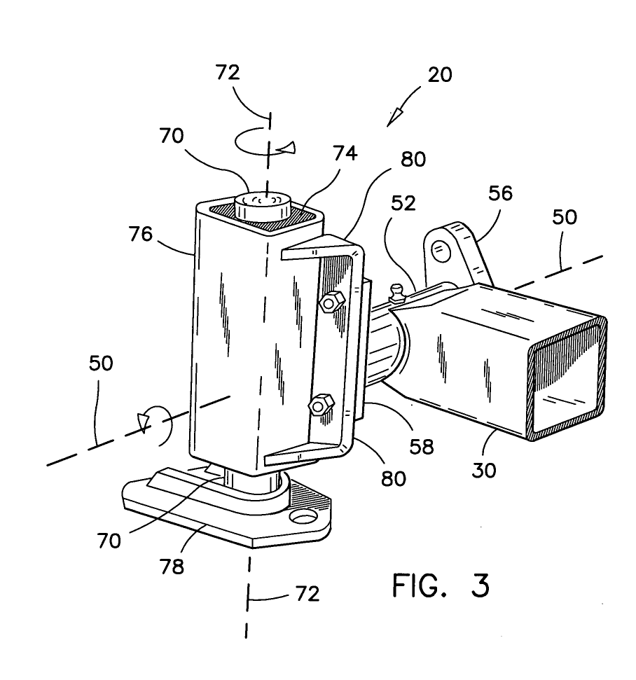

Referring now specifically to FIG. 3, the preferred mounting joint 20 will be explained. The preferred mounting joint 20 has two axes of articulation at right angle from each other. The first axis of articulation 50 extends horizontally along a shaft and bearing assembly 52. The shaft and bearing assembly 52 is mounted to the end of the extension beam 30. The extension beam 30 is shown in a partial view in FIG. 3, representing a cut-away view thereof.

The shaft and bearing assembly 52 is well known in forest machinery industry. The shaft 54 (partly shown in FIG. 4) pivots inside a lubricated bearing housing that is welded to the end of the extension beam 30. The shaft 54 has on its drive end a crank arm 56, and an anchor plate 58 on its driven end. It will be understood that a force applied to the crank arm 56 causes the shaft 54 and the anchor plate 58 to rotate about the axis 50. In use, an hydraulic cylinder 60 is mounted between the extension beam 30 and the crank arm 56 to rotate the anchor plate 58 about the axis 50. This hydraulic cylinder 60 is illustrated in FIG. 1.

Still referring to FIG. 3, the preferred mounting joint 20 has a wrist pin 70 extending along a second axis 72, at a right angle with the first axis 50. The wrist pin 70 has a rubber jacket 74 vulcanized to its surface. This wrist pin 70 and jacket 74 are held in a compressed mode and are mounted in a square tube 76, such that the wrist pin 70 has torsional resilience about the axis 72 for absorbing torsional stresses thereon. The lower end of the wrist pin 70 has a mounting plate 78 welded thereto. The square tube 76 has a mounting bracket 80 welded to it. This mounting bracket 80 is bolted or otherwise affixed to the anchor plate 58 on the shaft and bearing assembly 52.

The wrist pin 70, the rubber jacket 74, the square tube 76, and the mounting plate 78 and bracket 80 jointly constitute a resilient linkage in the preferred mounting joint. This resilient linkage is also referred to herein as the resilient wrist pin assembly.

Referring now to FIG. 4, the mounting plate 78 is made to be attached to the L-shaped support bracket 46. This L-shaped support bracket 46 is affixed to the main frame plate 92 of the sickle bar 22. The L-shaped support bracket 46 also retains the hydraulic motor 44 and the crank disc 40 relative to the main frame plate 92, as explained previously.

As can be seen in FIGS. 1, 2 and 4 the support bracket 46 and the preferred mounting joint 20 are mounted at an intermediate position along the main frame plate 92. This mounting is advantageous for mowing ahead of the tractor's right-side wheel path as can be understood from the illustration in FIG. 1.

This mounting also reduces excessive strain on the preferred mounting joint 20 from an overhung sickle bar 22. While it is possible to install the preferred mounting joint 20 at the centre of the main frame plate 92, it has been found that a mounting offset from the bar's centre is advantageous and more efficient in most situations. Still a preferred placement of the mounting joint 20 along the sickle bar 22 is about one third to one fifth of the sickle bar's length, from the near end of the sickle bar 22.

It will also be appreciated that the actuation of the hydraulic cylinder 60 causes the sickle bar 22 to move from a horizontal to a vertical orientation as illustrated in FIGS. 1 and 2, to mow grass and weed on the ground or to trim branches on mature trees bordering a forest road. It will also be appreciated that the angle of adjustment of the sickle bar 22 can vary in a range that is larger than 90°. This angle varies with the stroke length of the hydraulic cylinder 60 and depends on the choice of the designer. A range of motion of 120° is preferred with this mounting joint 20 to mow grass along the downward slope of a road shoulder for example.

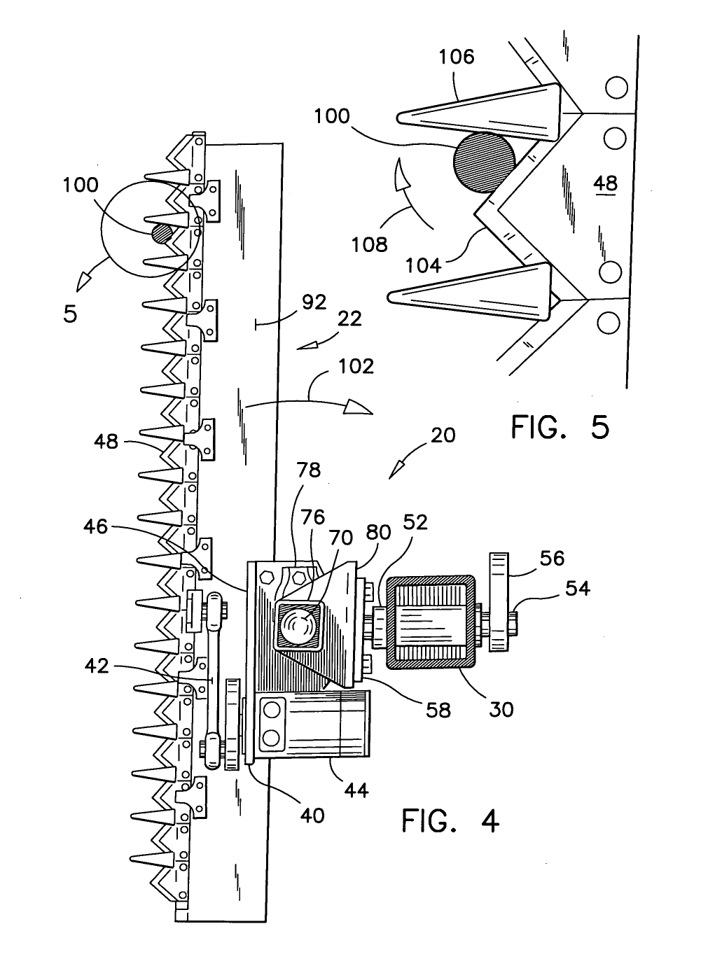

Referring now to FIGS. 4 and 5, there is illustrated therein a representation of a branch 100 being cut by the sickle bar 22 along the upper end of the sickle bar 22. When a heavy branch is being cut by the sickle bar 22, the hydraulic motor 44 may slow down momentarily or dwell slightly, to let hydraulic pressure build up to cut that branch. As a consequence, and because the tractor is in a forward movement, a backward force is applied by the branch to the sickle bar 22 causing the sickle bar 22 to tilt backward about the axis 72, as indicated by arrow 102 in FIG. 4. The movement of the sickle bar 22 in the direction 102, causes the blade 104 and the finger 106 holding the branch 100 to pinch, pull and twist the branch 100 in the direction of arrow 108 in FIG. 5. The resultant tension and torsion stresses applied to that branch 100 make it easier to cut that branch.

In order to understand this phenomenon, the reader is invited to consider cutting a branch or a raw carrot with a pocket knife. A movement of the wrist to move the knife blade about the branch's axis will produce better result than trying to cut the branch straight across by shear pressure. It has been found that wood fibres under stress, even slight, are easier to cut.

If a number of branches are being cut at the same time, the sickle bar 22 also tilts backward to twist all these branches to facilitate cutting of these branches. The torsion stresses applied to branches being cut has been found to enhance the efficiency of the sickle bar 22.

The same phenomenon exists when cutting branches in the lower portion of the sickle bar 22 below the preferred mounting joint 20. The torsion stresses applied to branches are simply in the opposite direction.

As soon as a branch is cut, the sickle bar 22 returns to its vertical alignment due to the resiliency of the rubber-mounted wrist pin 70. A same advantage has been found when the sickle bar 22 is operated horizontally. This is partly due to the axis 72 of the wrist pin 70 being always oriented in a vertical plane and at a right angle with the direction of travel of the tractor.

In view of the above, it will be appreciated that the oscillatory movement of the sickle bar 22 under load about axis 72 has advantageous effects on the cutting of branches along a forest road.

What is claimed is;:

1. A mounting joint for mounting between a tractor-mounted frame and a sickle bar; said mounting joint comprising;
a first and second axes extending at right angle from each other;
a shaft and bearing assembly extending along said first axis, said shaft and bearing assembly comprising a shaft and a bearing housing, and said shaft having axial mobility about said first axis relative to said bearing housing and a crank arm mounted thereon for controllably rotating said shaft about said first axis, and
a resilient wrist pin assembly mounted along said second axis; said resilient wrist pin assembly having torsional resilience about said second axis;
said shaft and bearing assembly comprising a first connection for attachment to a tractor-mounted frame and a second connection connected to said resilient wrist pin assembly, and said resilient wrist pin assembly comprising a third connection connected to a sickle bar; such that said sickle bar is controllably rotatable about said first axis and resiliently rotatable about said second axis.

2. The mounting joint as claimed in claim 1, wherein said first, second and third connections are rigid connections.

3. The mounting joint as claimed in claim 1, wherein said resilient wrist pin assembly comprises a wrist pin with rubber vulcanized thereon mounted in a square tubing.

4. The mounting joint as claimed in claim 1, wherein said first axis extends horizontally and said second axis lies in a vertical plane.

5. A tractor-mounted sickle bar, comprising a mounting joint having
a first and second axes extending at right angle from each other;
a shaft and bearing assembly extending along said first axis, said shaft and bearing assembly comprising a shaft and a bearing housing, and said shaft having mobility about said first axis relative to said bearing housing and a crank arm mounted thereon for controllably rotating said shaft about said first axis, and
a resilient wrist pin assembly mounted along said second axis; said resilient wrist pin assembly having resilience about said second axis;
said shaft and bearing assembly comprising a first connection connected to a tractor-mounted frame and a second connection connected to said resilient wrist pin assembly, and said resilient wrist pin assembly comprising a third connection connected to said sickle bar; such that said sickle bar is controllably rotatable about said first axis and resiliently rotatable about said second axis.

6. The tractor-mounted sickle bar as claimed in claim 5, wherein said first, second and third connections are rigid connections

7. The tractor-mounted sickle bar as claimed in claim 5, wherein said resilient wrist pin assembly comprises a wrist pin with rubber vulcanized thereon mounted in a square tubing.

8. The tractor-mounted sickle bar as claimed in claim 5, further comprising an hydraulic cylinder connected to said crank arm for rotating said shaft relative to said bearing housing.

9. The tractor-mounted sickle bar as claimed in claim 5, wherein said first axis extends horizontally and said second axis lies in a vertical plane.

10. The tractor-mounted sickle bar as claimed in claim 5 , wherein said mounting joint is affixed to said sickle bar offset from a centre of said sickle bar.

11. The tractor-mounted sickle bar as claimed in claim 10, wherein said sickle bar is driven by an hydraulic motor.

12. The tractor-mounted sickle bar as claimed in claim 11, further comprising a L-shaped mounting bracket affixed to said sickle bar and said mounting joint and said hydraulic motor are affixed to said L-shaped mounting bracket.

13. The tractor-mounted sickle bar as claimed in claim 12, wherein said L-shaped support bracket is mounted to said sickle bar at a distance from an end of said sickle bar of one third a length of said sickle bar.

14. The tractor-mounted sickle bar as claimed in claim 13 further comprising a tractor having front-loader arms and a quick coupler mounted to said front loader arms, and said sickle bar being mounted to said quick coupler.

15. The tractor-mounted sickle bar as claimed in claim 14 further comprising a telescoping beam mounted to said quick coupler and said shaft and bearing assembly is affixed to said telescoping beam.

16. A sickle bar with a mounting joint mounted thereto, said mounting joint comprising;
a first and second axes extending at right angle from each other;
a shaft and bearing assembly extending along said first axis, said shaft and bearing assembly comprising a shaft and a bearing housing, and said shaft having mobility about said first axis relative to said bearing housing and a crank arm mounted thereon for controllably rotating said shaft about said first axis, and
a resilient wrist pin assembly mounted along said second axis; said resilient wrist pin assembly having resilience about said second axis;
said shaft and bearing assembly comprising a first connection for connection to a support frame and a second connection connected to said resilient wrist pin assembly said resilient wrist pin assembly comprising a third connection connected to said sickle bar; such that said sickle bar is controllably rotatable about said first axis and resiliently rotatable about said second axis.

17. The sickle bar as claimed in claim 16, wherein said third connection comprising a L-shaped mounting bracket, and further comprising an hydraulic motor mounted to said L-shaped mounting bracket.

18. The sickle bar as claimed in claim 17 wherein said L-shaped support bracket is mounted to said sickle bar offset from a center of said sickle bar.

19. The sickle bar as claimed in claim 18, wherein said L-shaped support bracket is mounted to said sickle bar at a distance from an end of said sickle bar of one third a length of said sickle bar.

20. The sickle bar as claimed in claim 16, wherein said first axis extends horizontally and said second axis lies in a vertical plane.
